(19) United States
(12) Patent Application Publication
(10) Pub. No.: US 2008/0024008 A1
(43) Pub. Date: Jan. 31, 2008

(54) Household self-contained power supply

(76) Inventors: Ting-Yin Chiu, Taichung County (TW); Calvin Liu, Irvine, CA (US)

Correspondence Address: BACON & THOMAS, PLLC, 625 SLATERS LANE, FOURTH FLOOR, ALEXANDRIA, VA, 22314, US

(21) Appl. No.: 11/634,192

(22) Filed: Dec. 6, 2006

(30) Foreign Application Priority Data
Jul. 5, 2006 (TW) 095211829

(51) Int. Cl. H02J 9/00

(52) U.S. Cl. 307/23

(57) ABSTRACT

A household self-contained power supply combined with, what a civil residence has equipped, a panel board, a mains power supply line, and a plurality of sockets. The panel board includes a plurality of breakers. The household self-contained power supply is composed of a power line network module, a battery unit, a control unit, an automatic changeover switch, and a plurality of adaptors. Each of the adaptors includes a sub-plug, at least one sub-socket, an electrically-controlled switch, and a sub-power-line network module. The mains power supply line is connected with the power line network module, such that the electrically-controlled switch can be controlled by the control unit to control the conduction status between the sub-plugs and the sub-sockets. Therefore, it provides a self-contained power source and self-management thereof.

### BACKGROUND OF THE INVENTION

1. Field of the Invention

The present invention relates generally to the power supply technology, and more particularly, to a household self-contained power supply adapted for supplying household auxiliary or private power source.

2. Description of the Related Art

An auxiliary power generator, an example of the conventional auxiliary power supply, is operated to generate electricity based on self-contained oil to continue supplying power for emergent illumination or keeping a specific device running.

When the power generator generates electricity, it must be insulated from the mains line; otherwise, the power generator will be overloaded because all of the electrical appliances located in the blackout area will take the power from the power generator. Thus, it is necessary to provide an automatic transfer switch (ATS) for switching the load connected with the mains power to the load connected with the power generator to enable the load to take the power from the power generator.

In addition, one of the most popular small auxiliary power supply devices at present is typically the uninterruptible power supply (UPS) for use with the computer. The UPS is plugged into the mains power and then the computer is plugged into the UPS. In peacetime, the UPS takes the mains power to charge itself and the mains power is directly connected with the computer. When the mains power fails, the UPS directly supplies power for the computer other than the household mains power line.

Limited to the size and the price of the UPS, most of the household UPSs range between 1 KV and 2 KV and thus can merely provide the computer with the power lasting for less than one hour. Further, most of the household UPS is usually designed for providing power for the computer. Until now, no one has proposed any approach employing the UPS to provide power for any indoor socket because it is primarily limited to the insufficient power of the UPS itself and the difficulty of controlling power supply for the individual indoor socket.

### SUMMARY OF THE INVENTION

The primary objective of the present invention is to provide a household self-contained power supply, which can provide the indoor sockets with power while the mains power fails.

The secondary objective of the present invention is to provide a household self-contained power supply, which can manage the indoor sockets and provide power for electrical appliances designated by the user.

The foregoing objectives of the present invention are attained by the household self-contained power supply combined with, what a civil residence has equipped, a panel board, a mains power supply line, and a plurality of sockets. The panel board includes a plurality of breakers connected between the external mains power and the mains power supply line of the civil residence. The household self-contained power supply is composed of a power line network module, a battery unit, a control unit, an automatic changeover switch, and a plurality of adaptors. The power line network module is connected with the mains power supply line. The battery unit is connected with the power line network module. The control unit is connected with the power line network module. The automatic changeover switch includes a first changeover end, a second changeover end, and a common end. The first changeover end is connected with a breaker. The second changeover end is connected with the battery unit. The common end is connected with the mains power supply line. The automatic changeover switch enables electrical conduction between the first changeover end and the common end while the electricity is still received from the breaker and enables the electrical conduction between the second changeover end and the common end while no electricity is received from the breaker. Each of the adaptors includes a sub-plug, at least one sub-socket, an electrically-controlled switch, and a sub-power-line network module. The electrically-controlled switch is connected with the sub-plugs, the sub-sockets, and the sub-power-line network module. The sub-plugs are plugged into a plug of the civil residence to enable the sub-power-line network module to be connected with the power line network module. The sub-sockets are adapted for plugging plugs of household appliances therein. Because the sub-power-line network module is connected with the power line network module, the electrically-controlled switch can be controlled by the control unit to be switched ON/OFF, thus controlling whether the sub-plugs and the sub-sockets are electrically conducted.

### BRIEF DESCRIPTION OF THE DRAWINGS

FIG. 1 is a schematic structural view of a preferred embodiment of the present invention.

FIG. 2 is another schematic structural view of the preferred embodiment of the present invention.

FIG. 3 is another schematic structural view of the preferred embodiment of the present invention.

FIG. 4 is another schematic structural view of the preferred embodiment of the present invention, illustrating that the adaptor has a plurality of sub-plugs.

FIG. 5 is another schematic structural view of the preferred embodiment of the present invention, illustrating that the charging source is a solar panel.

FIG. 6 is another schematic structural view of the preferred embodiment of the present invention, illustrating that a manual switch is additionally mounted.

### DETAILED DESCRIPTION OF PREFERRED EMBODIMENTS

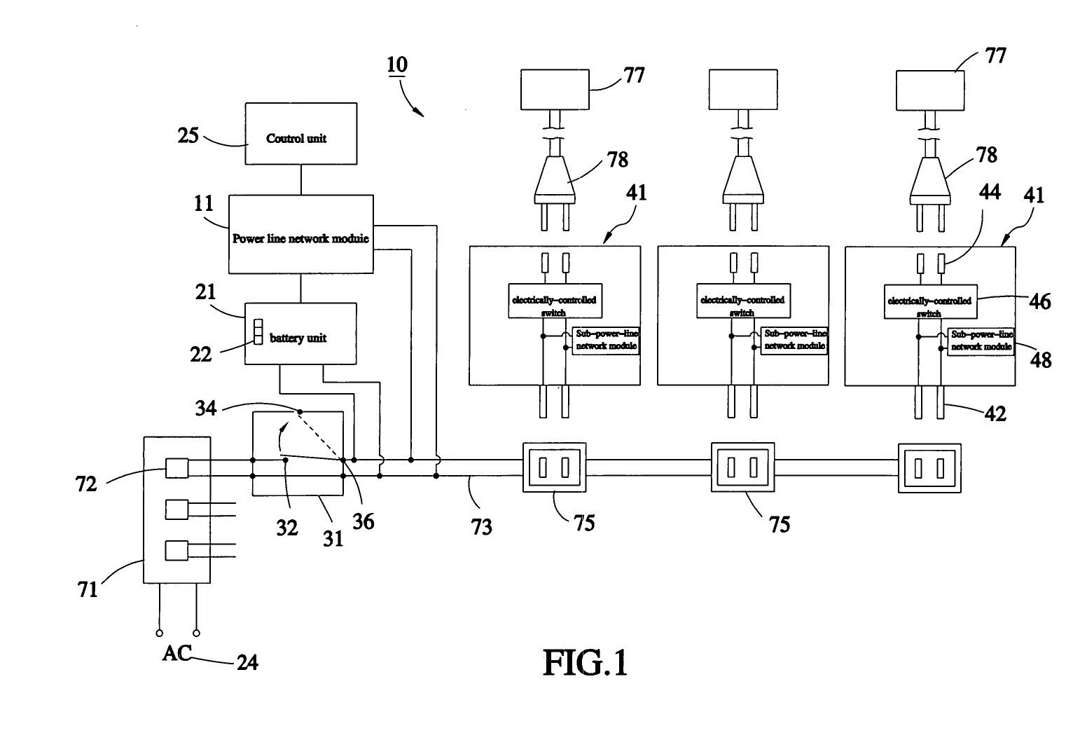

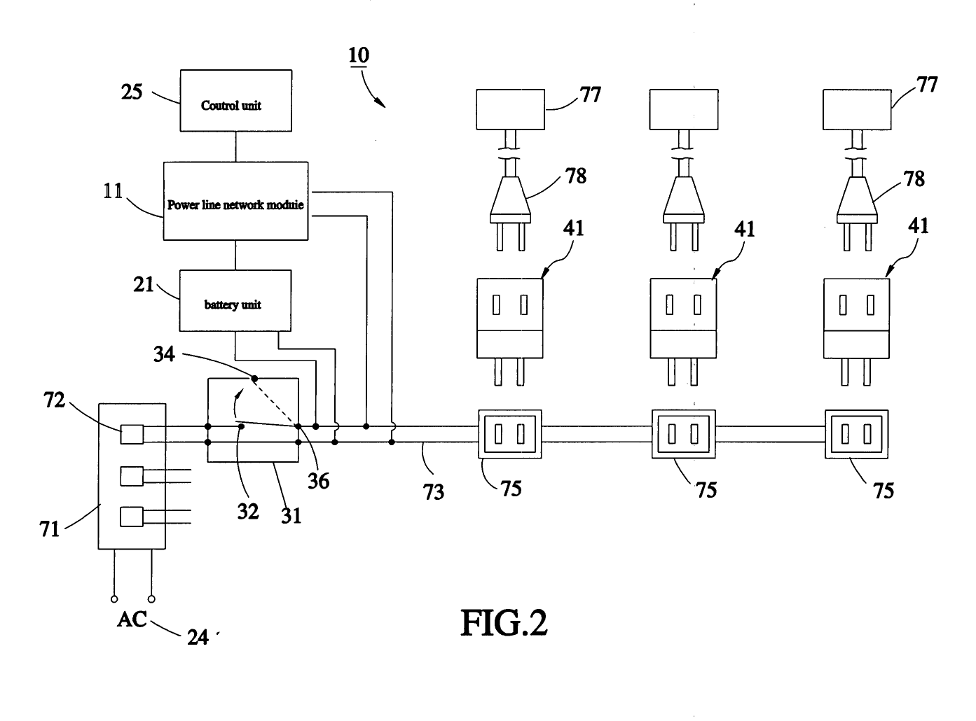

Referring to FIGS. 1 and 2, a household self-contained power supply 10 constructed according to a preferred embodiment of the present invention is combined with what the civil residence is equipped, i.e. a panel board 71, a mains power supply line 73, and a plurality of sockets 75. The panel board 71 includes a plurality of breakers 72 connected between an external mains power and the mains power supply line 73. The sockets 75 are connected with the mains power supply line 73. The household self-contained power supply 10 is composed of a power line network module 11, a battery unit 21, a control unit 25, an automatic changeover switch 31, and a plurality of adaptors 41.

The power line network module 11 is connected with the mains power supply line 73.

The battery unit 21 is connected with the power line network module 11, including a rechargeable battery 22 which is an UPS in this embodiment for changeover between a charging status and a power-supply status as desired. The battery unit 21 is connected with a charging source 24 which is the mains power in this embodiment for charging the battery unit 21 through the mains power supply line 73.

The control unit 25 is connected with the power line network module 11.

The automatic changeover switch 31 includes a first changeover end 32, a second changeover end 34, and a common end 36. The first changeover end 32 is connected with a breaker 72. The second changeover end 34 is connected with the battery unit 21. The common end 36 is connected with the mains power supply line 73. When the electricity still comes from the breaker 72, the automatic changeover switch 31 enables the first changeover end 32 to be electrically conducted with the common end 36. When no electricity comes from the breaker 72, the automatic changeover switch 31 switches the aforesaid status to the status that the second changeover end 32 is electrically conducted with the common end 36.

Each of the adaptors 41 includes a sub-plug 42, a sub-socket 44, an electrically-controlled switch 46, and a sub-power-line network module 48. Each of the electrically-controlled switches 46 is a relay in this embodiment and connected with the sub-plug 42, the sub-socket 44, and the sub-power-line network module 48. The sub-plugs 42 are plugged into plugs 75 located in the civil residence to enable the sub-power-line network module 48 to be connected with the power line network module 11, for plugging plugs 78 of household appliances 77 therein. The connection between the power line network module 11 and each of the sub-power-line network modules 48 enables the electrically-controlled switches 46 to be controlled by the control unit 25 to switch ON/OFF, thus controlling whether the sub-plugs 42 and the sub-sockets 44 are electrically conducted or not.

As shown in FIG. 2, while the present invention is operated, the adaptors 41 are plugged into the sockets 75 respectively through the sub-sockets 42 and the plugs 78 of the household appliances 77 are plugged into the sub-sockets 44 of the adaptors 41. Further, each of the adaptors 41 can be set through the control unit 25 beforehand to take the electric energy from the battery unit 21 while the mains power fails.

When the mains power operates normally, the electrically-controlled switches 46 keep the sub-plus 42 and the sub-sockets 44 in electrical conduction therebetween and the household appliances 77 take the electric energy directly from the mains power. In the meantime, the battery unit 21 is under the charging status and keeps being charged through the mains power.

When the mains power fails, the automatic changeover switch 31 automatically switches the common end 36 electrically conducted with the first changeover end 32 to the common end 36 electrically conducted with the second changeover end 34 and thus the battery unit 21 is switched to power-supply status for supplying power for the mains power supply line 73. Through the connection between the sub-power-line network modules 48 and the power line network module 11, the control unit 25 can control the conduction status of each adaptor 41 according to the default setting. Specifically, the control unit 25 either keeps the electrical conduction between the sub-plugs 42 and the sub-sockets 44 to enable the household appliances 77 electrically connected with the adaptors 41 to take the electric energy from the battery unit 21 or sets open circuit between the sub-plugs 42 and the sub-sockets 44 to disable the household appliances 77 from taking the electric energy from the battery unit 21.

In light of above, the above-mentioned art can enable the battery unit 21 to supply its electric energy for the indoor sockets 75 and further manage the indoor sockets 75 to provide the electric energy for the household appliances 77 that the user specifically designates.

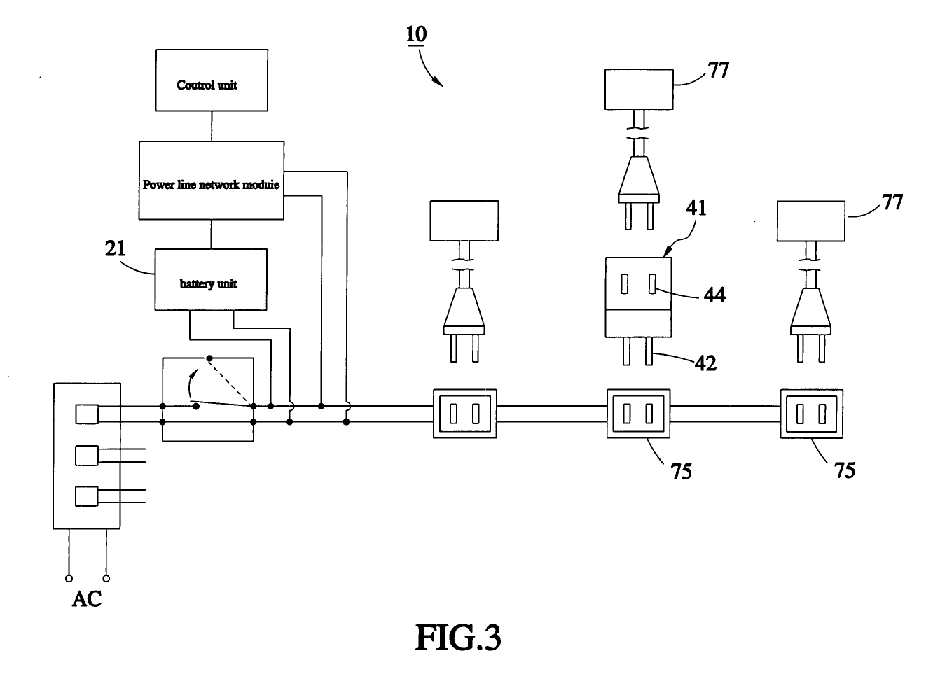

Referring to FIG. 3 showing an alternative connection status of the present invention, the household appliances 77 are set not to take the electrical energy from the battery unit 21 when the mains power fails, plugged into the sub-sockets 44 and then indirectly into the sockets 75 through the sub-plugs 42 of the adaptors 41. The adaptors 41 are set not to take the electric energy from the battery unit 21 when the mains power fails. If intending to take the electric energy from the battery unit 21, the household appliances 77 can be directly plugged into the sockets 75.

In light of such connection, when the mains power operates normally, all of the household appliances 77 plugged into the sockets 75 and adaptors 41 can normally take the electric energy from the mains power. When the mains power fails, the electric energy of the battery unit 21 can be directly taken by the household appliances 77 plugged into the sockets 75. In the meantime, the household appliances 77 plugged into the adaptors 41 fail to take the electric energy from the battery unit 21 because of the open circuit of the adaptors 41. Thus, it achieves selective power supply.

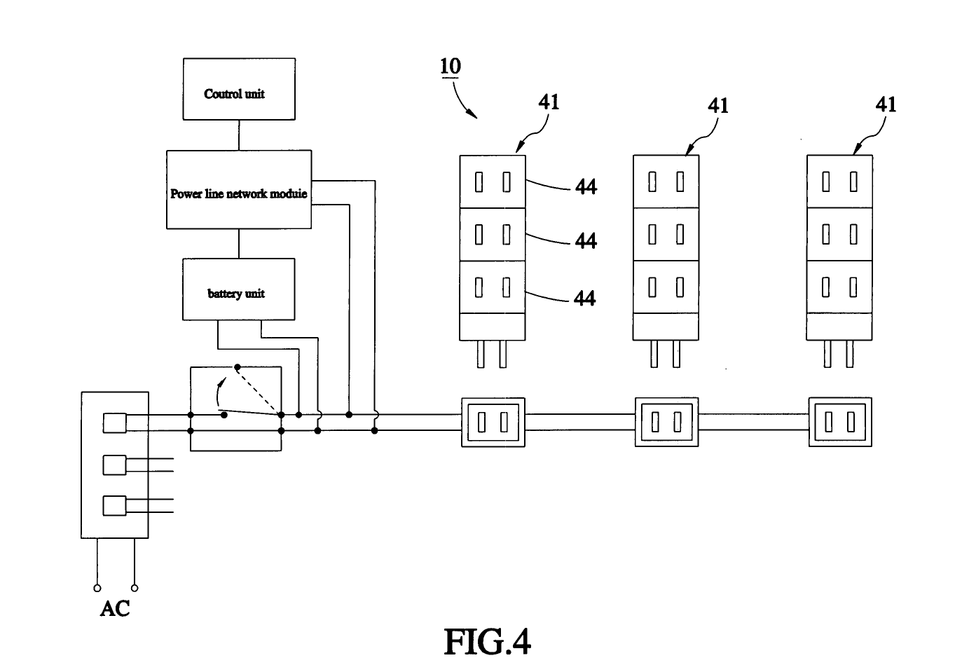

Referring to FIG. 4, the adaptors 31 can have several sub-sockets 44 located thereon. In other words, the number of the sub-sockets 44 on each of the adaptors 41 is not limited to one.

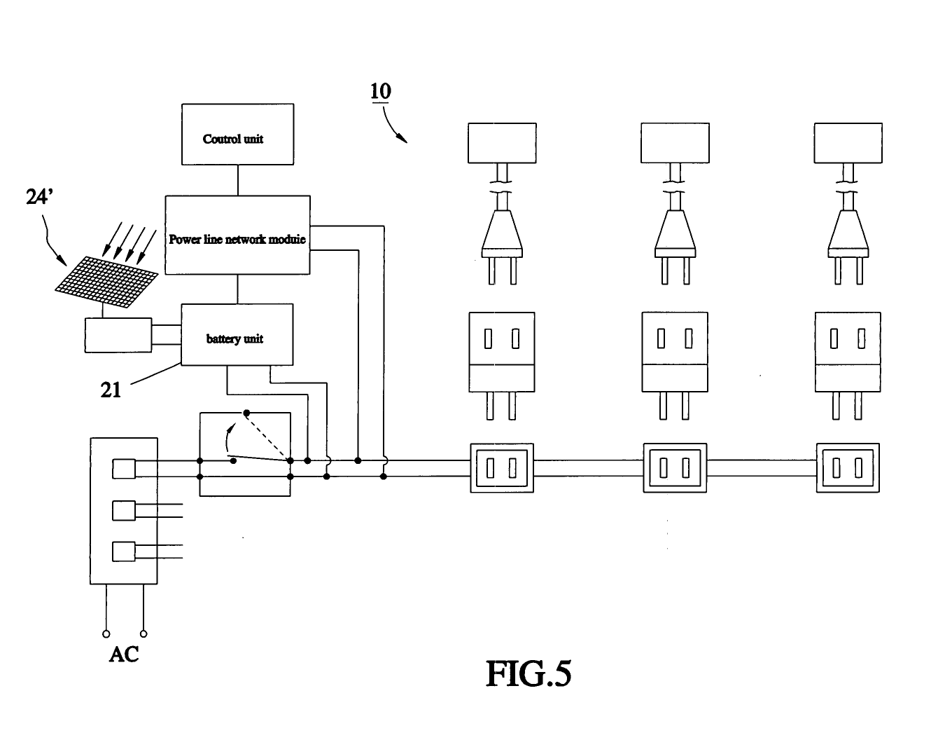

Referring to FIG. 5, the charging source 24′ can be a solar panel mounted outdoor or on the roof of the residence for converting the solar energy into the electric energy and then storing the electric energy in the battery unit 21.

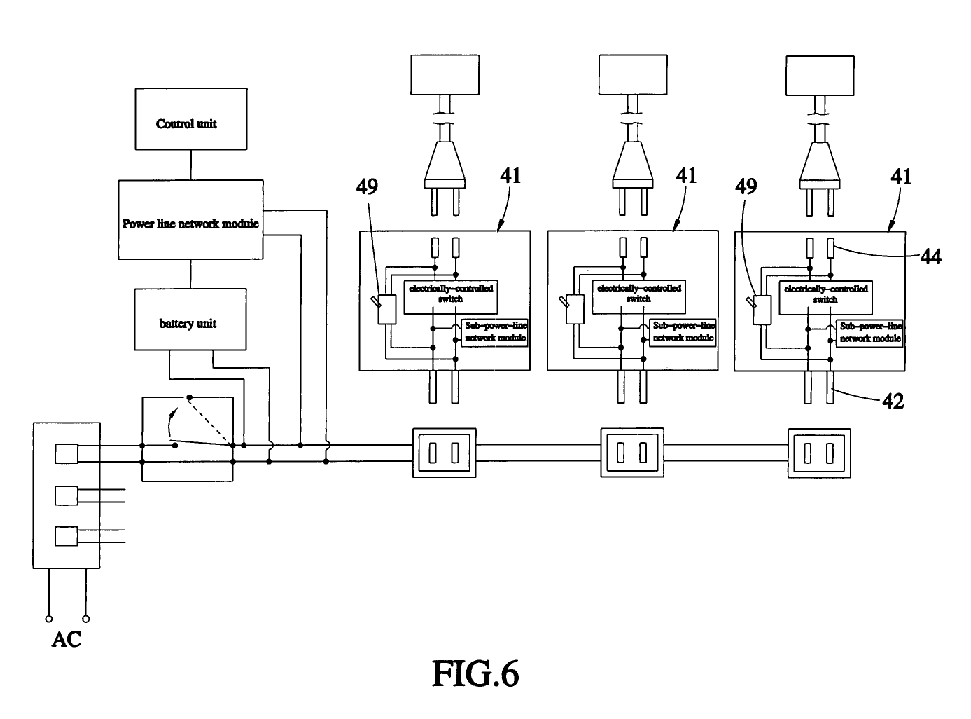

Referring to FIG. 6, each of the adaptors 41 can further include a manual switch 49 mounted thereon connected between the sub-socket and the sub-plug 42 for enabling the user to manually switch the conduction status of each of the adaptors 41, thus enhancing the convenience of the setting.

In conclusion, the present invention includes the following advantages.

1. Providing a self-contained power source
The present invention can be a self-contained power source instead of the mains power for indoor power supply while the mains power fails. As the power capacity of the battery 22 purchased by the user increases, the energy of the power supply will enhance. Further, the user can directly switch off the breaker 72 to shut off the mains power temporarily to take the electric energy from the battery unit 21, thus achieving energy saving and environmental protection. If the charging source is the solar energy or the power generator based on the natural resource, like small wind-power or waterpower generator, it will be more environment-protective and power-saving.

2. Setting and management based on requirement
The present invention can selectively control which household appliances 77 take the electric energy from the battery unit 21 according to the power capacity of the purchased battery 22 and the power consumptions of the household appliances 77, thus being free and convenient in selective control.

Although the present invention has been described with respect to a specific preferred embodiment thereof, it is no way limited to the details of the illustrated structures but changes and modifications may be made within the scope of the appended claims.

What is claimed is:

1. A household self-contained power supply combined with, what a civil residence has equipped, a panel board, a mains power supply line, and a plurality of sockets, said panel board having a plurality of breakers connected between an external mains power and said mains power supply line, said sockets being connected with said mains power supply line, said household self-contained power supply comprising:
a power line network module connected with said mains power supply line;
a battery unit connected with said power line network module;
a control unit connected with said power line network module;
an automatic changeover switch having a first changeover end, a second changeover end, and a common end, said first changeover end being connected with a breaker, said second changeover end being connected with said battery unit, said common end being connected with said main power supply line; and
a plurality of adaptors each having a sub-plug, at least one sub-socket, an electrically-controlled switch, and a sub-power-line network module, said electrically-controlled switches being connected with said sub-plugs, said sub-sockets, and said sub-power-line network modules, said sub-plugs being plugged into the sockets of the civil residence to enable said sub-power-line network modules to be connected with said power line network module, said sub-sockets being adapted for plugging plugs of household appliances therein, whereby said electrically-controlled switches can be controlled by said control unit to switch ON/OFF to further control whether said sub-plug and said sub-sockets are electrically conducted.

2. The household self-contained power supply as defined in claim 1, wherein said battery unit comprises a rechargeable battery.

3. The household self-contained power supply as defined in claim 2, wherein said battery unit is an uninterruptible power supply (UPS) connected with a charging source and can be switched between a charging status and a power-supply status as desired.

4. The household self-contained power supply as defined in claim 3, wherein said charging source is the mains power for providing power for said battery unit through said mains power supply line.

5. The household self-contained power supply as defined in claim 3, wherein said charging source is a solar panel.

6. The household self-contained power supply as defined in claim 1, wherein each of said adaptors comprises a manual switch connected between said sub-socket and said sub-plug for manually switching ON and OFF therebetween.

7. The household self-contained power supply as defined in claim 1, wherein said electrically-controlled switch is a relay.
